(19) United States
(12) Patent Application Publication
(10) Pub. No.: US 2019/0010912 A1
(43) Pub. Date: Jan. 10, 2019

(54) HYDRAULIC-CIRCULATION POWERED ENGINE

(71) Applicant: Nien-Fa Chou, Taoyuan City (TW)

(72) Inventor: Nien-Fa Chou, Taoyuan City (TW)

(21) Appl. No.: 15/646,081

(22) Filed: Jul. 10, 2017

(51) Int. Cl. F03B 1/04; B60K 3/04

(52) U.S. Cl. CPC F03B 1/04; B60K 3/04

(57) ABSTRACT

A hydraulic-circulation powered engine includes: a housing, defining a chamber inside; a rotating disk, a periphery thereof configured with a plurality of sequentially arranged driven elements, the rotating disk configured inside the chamber, and a rotating shaft outputting power configured on a shaft center of the rotating disk and extended out of the housing; a plurality of nozzles, configured on the chamber, and sequentially arranged outside the periphery of the rotating disk, allowing the nozzles to face the driven elements; a liquid pressurizing driver, configured with liquid outlet in communication with the nozzles; and a power supply, in electric connection with the liquid pressurizing driver, allowing the liquid pressurizing driver to be driven to output liquid to each nozzle, thereby ejecting liquid toward the driven elements configured on the periphery of the rotating disk so as to drive the driven elements to turn the rotating disk and rotating shaft.

### (a) TECHNICAL FIELD OF THE INVENTION

The present invention relates to a hydraulic-circulation powered engine, and more particularly to an engine powered by means of hydraulic circulation, and to a housing, rotating disk, liquid pressurizing driver and power supply thereof.

### (b) DESCRIPTION OF THE PRIOR ART

Conventional engines of automobiles, motorcycles and other vehicles are mainly adopted with an internal combustion engine in which fuel is used to generate power; such kinds of engines, upon operation, must consume the limited fuel resources of the earth and will generate gases harmful to the environment such as carbon dioxide, sulfur monoxide and hydrocarbons, which cause air pollution easily. To reduce the consumption of fuel resources and air pollution, vehicle engines powered by electric energy are currently available in the market; such kinds of engines are provided with electric energy through batteries, allowing them to generate power through the magnetism of a coil operated in coordination with magnet so as to drive vehicle wheels to turn. In addition, using water, hydraulic oil or the like as a media to drive hydraulic cylinders to output power to be used as a power source for automatic control machine has been a prior art. But, the current technologies still cannot use the above liquid operated in coordination with hydraulic cylinders to generate engine power and drive vehicles to move.

### SUMMARY OF THE INVENTION

To overcome the defects mentioned above, the present invention is proposed.

The main object of the present invention is to provide a hydraulic-circulation power engine, using hydraulically pressurized liquid to generate engine power and drive vehicles to move.

To achieve the object mentioned above, the present invention proposes a hydraulic-circulation powered engine, including: a housing, defining a chamber inside; a rotating disk, a periphery thereof configured with a plurality of sequentially arranged driven elements, the rotating disk configured inside the chamber, and a rotating shaft capable of outputting power configured on a shaft center of the rotating disk and extended out of the housing; a plurality of nozzles, configured on the chamber, and sequentially arranged outside the periphery of the rotating disk, allowing the nozzles to face the driven elements; a liquid pressurizing driver, configured with liquid outlet in communication with the nozzles; and a power supply, in electric connection with the liquid pressurizing driver, allowing the liquid pressurizing driver to be driven to output liquid to each the nozzle through the liquid outlet with electricity supply of the power supply, each the nozzle to eject liquid toward the driven elements configured on the periphery of the rotating disk so as to drive the driven elements to turn the rotating disk and rotating shaft.

With the above structural characteristics, the liquid circulation power engine can be applied in automobiles, motorcycles, or other vehicles. Using the power supply to provide the liquid pressurizing driver with required operation electric energy, allowing the liquid pressurizing driver to provide the nozzles with high pressure liquid, and the plurality of nozzles to respectively eject liquid to push the walls of the driven elements to move to drive the driven elements to turn the rotating disk and rotating shaft so that the rotating shaft outputs power to the wheels of the vehicle to move the vehicle. In addition, using the rotating shaft to drive the generator to generate electricity allows the storage battery to store the electric energy for the electricity generation, and the storage battery to supply or resupply the power supply 6 with electric energy so as to achieve the effect of generating engine power with the hydraulic-circulation power supply.

According to the above main structural characteristics, a liquid ejecting line of the nozzle is tangent to the periphery of the rotating disk, and the driven element is configured with a wall positioned at a location where the liquid ejecting line is tangent to the periphery of the rotating disk.

According to the above main structural characteristics, the driven element is a groove or blade.

According to the above main structural characteristics, the liquid pressurizing driver is configured with a liquid inlet in communication with the chamber of the housing, capable of collecting liquid in the housing.

According to the above main structural characteristics, the liquid pressuring driver is configured with a liquid storage room and pump.

According to the above main structural characteristics, the rotating shaft is in connection with a generator, allowing the rotating shaft to drive the generator to generate electric energy, and the generator is in electric connection with a storage battery, allowing the electric energy to be stored in the storage battery.

According to the above main structural characteristics, the storage battery is in electric connection with the power supply, allowing the storage battery to provide the power supply with electric energy.

According to the above main structural characteristics, the power supply is a battery, and the liquid is water or hydraulic oil.

According to the above main structural characteristics, the housing, rotating shaft, liquid pressurizing driver and power supply are configured inside a vehicle, and the rotating shaft is in connection with wheels of the vehicle.

### BRIEF DESCRIPTION OF THE DRAWINGS

FIG. 1 is a schematic view of the structure configuration of a preferred embodiment according to the present invention;

FIG. 2 is a top view of FIG. 1; and

FIG. 3 is a functional block diagram of a liquid pressurizing driver structure of the present invention.

### DETAILED DESCRIPTION OF THE PREFERRED EMBODIMENTS

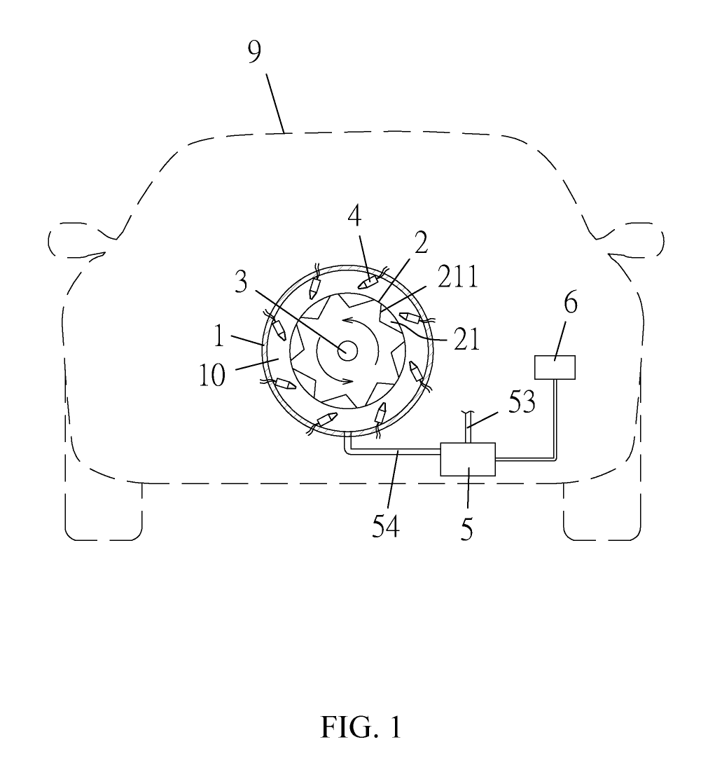

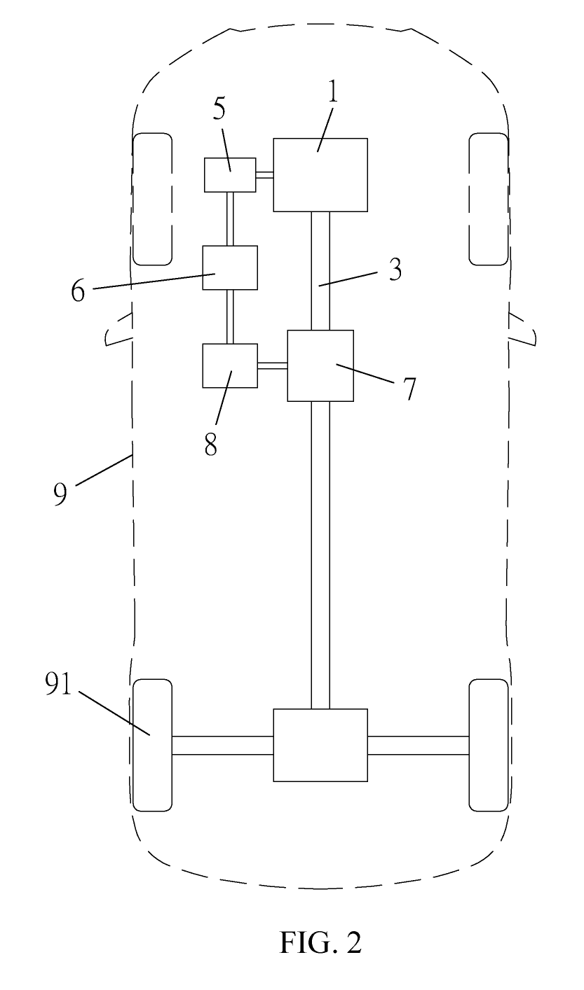

Referring to FIGS. 1 and 2, in a preferred embodiment, a hydraulic-circulation powered engine of the present invention includes a housing 1, a rotating disk 2, a rotating shaft 3, a plurality of nozzles 4, a liquid pressurizing driver 5 and a power supply 6, where the housing 1, rotating disk 3, liquid pressurizing driver 5 and power supply 6 are configured inside an automobile, motorcycle, or other vehicle.

A chamber 10 is configured inside the housing 1. The rotating disk 2 is a circular rotating disk and configured in the chamber 1, with the peripheral of the rotating disk 2 being configured with a plurality of sequentially-arranged driven elements 21. The rotating shaft 3 is in connection with the axle center of the rotating disk 2 and extended from the chamber 10 to the outside of the housing 1 so as to be in connection with wheels 91 of the vehicle 9, allowing the rotating shaft 3 to output the rotating power of the rotating disk 2 to the wheels 91 of the vehicle 9.

The nozzles 4 are respectively disposed in the chamber 10, and sequentially arranged outside the periphery of the rotating disk 2 and allowed to facing the driven elements 21. Furthermore, the liquid ejecting line of each nozzle 4 and is tangent to the periphery of the rotating disk 2, and the nozzles 4 can eject liquid to the driven elements 21. Specifically, the driven element 21 may be a groove or blade configured with a wall 211 positioned at a location where the liquid ejecting line is tangent to the periphery of the rotating disk 2.

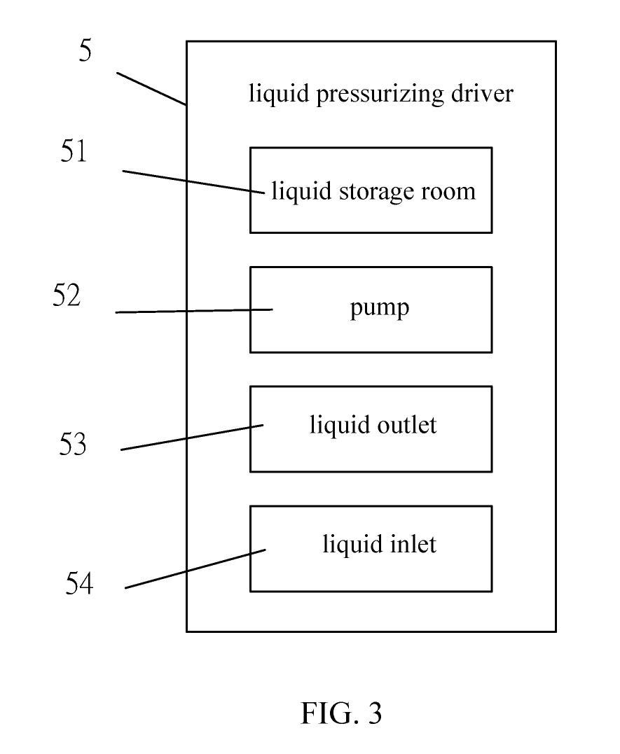

Referring to FIGS. 1 and 3, the liquid pressurizing driver 5 is configured with a liquid storage room 51, pump 52, liquid outlet 53 in communication with the nozzles 4, and liquid inlet 54 in connection with the bottom of the chamber 10 of the housing 1, where water or hydraulic oil can be stored in the liquid storage room 51, the pump 52 can be used to pressurize the liquid stored in the liquid storage room 51, the high pressure liquid is output to each nozzle 4 through the liquid outlet 53, and the liquid inlet 54 is used to collect the liquid in the chamber 10 of the housing so as to guide the liquid back to the liquid storage room 51.

The power supply 6 may be a battery in electric connection with the liquid pressurizing driver 5 and can supply electricity to drive the liquid pressurizing drivers to output the liquid to each nozzle 4 through the liquid outlet 53, allowing each nozzle 4 to eject the liquid toward the driven elements 21 configured on the periphery of the rotating disk 2 so as to drive the driven elements 21 to turn the rotating disk 2 and rotating shaft 3.

Referring to FIG. 2 again, in a preferred feasible embodiment, the rotating shaft 3 is in connection with a generator 7 to cause it to generate electric energy, and the generator 7 is further in electric connection with a storage battery 9, allowing the electric energy generated from the generator 7 to be stored in the storage battery 8, thereby providing the vehicle 9 with required electricity. Furthermore, the storage battery 8 may also be in electric connection with the power supply 6. Whereby, the storage batter 8 can provide the power supply 6 with electric energy when the electric energy of the power supply 6 is insufficient, and even charge the power supply 6.

With the above structural characteristics, the liquid-circulation powered engine of the present invention can be specifically applied in automobiles, motorcycles, or other vehicles. Using the power supply 6 to provide the liquid pressurizing driver 5 with required operation electric energy, allowing the liquid pressurizing driver 5 to provide the nozzles 4 with high pressure liquid, and the plurality of nozzles 4 to respectively eject liquid to push the walls 211 of the driven elements 21 to move to drive the driven elements 21 to turn the rotating disk 2 and rotating shaft 3 so that the rotating shaft 3 outputs power to the wheels 91 of the vehicle 9 to move the vehicle 2. In addition, using the rotating shaft 3 to drive the generator 7 to generate electricity allows the storage battery 8 to store the electric energy for the electricity generation, and the storage battery 8 to supply or resupply the power supply 6 with electric energy so as to achieve the effect of generating engine power with the hydraulic-circulation power supply.

I claim:

1. A high hydraulic-circulation powered engine, comprising:
a housing, defining a chamber inside;
a rotating disk, a periphery thereof configured with a plurality of sequentially arranged driven elements, said rotating disk configured inside said chamber, and a rotating shaft capable of outputting power configured on a shaft center of said rotating disk and extended out of said housing;
a plurality of nozzles, configured on said chamber, and sequentially arranged outside said periphery of said rotating disk, allowing said nozzles to face said driven elements;
a liquid pressurizing driver, configured with liquid outlet in communication with said nozzles; and
a power supply, in electric connection with said liquid pressurizing driver, allowing said liquid pressurizing driver to be driven to output liquid to each said nozzle through said liquid outlet with electricity supply of said power supply, each said nozzle to eject liquid toward said driven elements configured on said periphery of said rotating disk so as to drive said driven elements to turn said rotating disk and rotating shaft.

2. The engine according to claim 1, wherein a liquid ejecting line of said nozzle is tangent to said periphery of said rotating disk, and said driven element is configured with a wall positioned at a location where said liquid ejecting line is tangent to said periphery of said rotating disk.

3. The engine according to claim 1, wherein said driven element is a groove or blade.

4. The engine according to claim 2, wherein said driven element is a groove or blade.

5. The engine according to claim 1, wherein said liquid pressurizing driver is configured with a liquid inlet in communication with said chamber of said housing, capable of collecting liquid in said housing.

6. The engine according to claim 1, wherein said liquid pressuring driver is configured with a liquid storage room and pump.

7. The engine according to claim 1, wherein said rotating shaft is in connection with a generator, allowing said rotating shaft to drive said generator to generate electric energy, and said generator is in electric connection with a storage battery, allowing said electric energy to be stored in said storage battery.

8. The engine according to claim 7, wherein said storage battery is in electric connection with said power supply, allowing said storage battery to provide said power supply with electric energy.

9. The engine according to claim 1, wherein said power supply is a battery, and said liquid is water or hydraulic oil.

10. The engine according to claim 8, wherein said power supply is a battery, and said liquid is water or hydraulic oil.

11. The engine according to claim 1, wherein said housing, rotating shaft, liquid pressurizing driver and power supply are configured inside a vehicle, and said rotating shaft is in connection with wheels of said vehicle.
